(19) United States
(12) Patent Application Publication
(10) Pub. No.: US 2024/0145691 A1
(43) Pub. Date: May 2, 2024

(54) Positive Electrode Active Material for Lithium-Ion Battery, Lithium-Ion Battery and Method of Manufacturing the Same

(71) Applicant: CHE Inc., Kaohsiung City (TW)

(72) Inventors: CHUAN-PU LIU, Tainan City (TW); YIN-WEI CHENG, Kaohsiung City (TW); SHIH-AN WANG, Taipei City (TW); BO-LIANG PENG, Kaohsiung City (TW); CHUN-HUNG CHEN, New Taipei City (TW); JUN-HAN HUANG, Changhua County (TW); YI-CHANG LI, Changhua City (TW)

(21) Appl. No.: 18/121,005

(22) Filed: Mar. 14, 2023

(30) Foreign Application Priority Data
Oct. 28, 2022 (TW) 111141275

(51) Int. Cl. H01M 4/505; C01G 53/00; H01M 4/131; H01M 4/525; H01M 10/0525

(52) U.S. Cl. CPC H01M 4/505; C01G 53/50; H01M 4/131; H01M 4/525; H01M 10/0525; C01P 2002/02; C01P 2002/72; C01P 2006/40

(57) ABSTRACT

The present invention is related to a novel positive electrode active material for lithium-ion battery. The positive electrode active material is expressed by the following formula: Li_{1.2}NiₓMn_{0.8-x-y}Zn_{y}O₂, wherein x and y satisfy 0<x≤0.8 and 0<y≤0.1. In addition, the present invention provides a method of manufacturing the positive electrode active material. The present invention further provides a lithium-ion battery which uses said positive electrode active material.

### BACKGROUND OF THE PRESENT INVENTION

### Field of Invention

The present invention relates to a positive electrode active material for lithium-ion battery, and more specifically, to a positive electrode active material for lithium-ion battery with novel chemical composition.

### Description of Related Arts

With the development of technology and the increasing demand for mobile devices, the demand for secondary batteries as a source of energy is also increasing rapidly. Among these secondary batteries, commercially available lithium secondary batteries have high energy density and high voltage, long life and low self-charging characteristics, making them widely used.

Lithium-containing cobalt oxide (LiCoO₂) is commonly used as the positive electrode active material in lithium secondary batteries. Lithium-containing manganese oxides, such as LiMnO₂ with a layered crystal structure and LiMn₂O₄ with a spinel crystal structure, and lithium-containing nickel oxides (LiNiO₂) can also be used. Among the above-mentioned positive electrode active materials, LiCoO₂ is the most commonly used due to its superior physical properties (e.g., excellent cycling characteristics). However, LiCoO₂ is unstable and is expensive due to the resource limitation of raw material cobalt.

Lithium manganese oxides, such as LiMnO₂ and LiMnO₄, are alternatively used because manganese is abundant and environmentally friendly as a raw material, therefore making it a candidate for replacing LiCoO₂ as a positive electrode active material. However, these lithium-manganese oxides have the disadvantage of low capacitance and poor cycling characteristics.

Lithium-nickel oxides (e.g., LiNiO₂) are cheaper than cobalt oxides and have a higher discharge capacitance after charging to a certain state. Therefore, despite the lower average discharge voltage and bulk density, research has been widely devoted to develop high-capacity batteries, so the energy density of commercially available batteries including LiNiO₂ as the positive electrode active material has been improved in recently years. In this respect, conventional technologies focus on the properties of LiNiO₂-based negative electrode active materials and the improvement of LiNiO₂ processes. However, the disadvantages of LiNiO₂-based negative electrode active materials are high cost, the volume expansion caused by the gas generated from the cell, low chemical stability, and high pH manufacturing condition. These shortcomings are not yet overcome and unsatisfactory to current demands. In related fields, there are suggestions proposed to coat specific materials (e.g., LiF, Li₂SO₄, Li₃PO₄) on the surface of lithium-nickel-manganese-cobalt oxides in an attempt to improve the performance of the cells. In these circumstances, the addition of other elements to the lithium battery though brings some advantages in one hand, but also creates drawbacks in another hand (e.g., complicated process etc.). Manufacturers are committed to developing better lithium battery compositions.

Nevertheless, there is still a need to develop a lithium containing material with satisfactory performance as the positive electrode material for lithium-ion batteries.

### SUMMARY OF THE PRESENT INVENTION

The present invention therefore provides a positive electrode active material for lithium-ion battery, which has excellent electrical performance.

According to one embodiment of the present invention, a positive electrode active material for lithium-ion battery is provided. Said positive electrode active material has an average composition expressed by the following formula: Li_{1.2}NiₓMn_{0.8-x-y}Zn_{y}O₂, wherein x and y satisfy 0<x≤0.8 and 0<y≤0.1.

According to another embodiment of the present invention, a lithium-ion battery is provided. Said lithium-ion battery comprises an positive electrode active material having an average composition expressed by the following formula: Li_{1.2}NiₓMn_{0.8-x-y}Zn_{y}O₂, wherein x and y satisfy 0<x≤0.8 and 0<y≤0.1.

According to another embodiment of the present, a method of manufacturing a positive electrode active material for lithium-ion battery is provided. First, a first solution is provided, wherein the first solution includes a manganese salt solution, a nickel salt solution and a zinc salt solution. Next, a second solution is provided, wherein the second solution includes a chelating agent and a buffer solution. Then, the first solution is titrated into the second solution under a predetermined condition to produce a precipitation reaction, thereby forming a precursor material. Following by adding a lithium-containing compound into the precursor material, a heat process is performed to obtain the positive electrode active material.

By using the positive electrode active material and the lithium-ion battery using said positive electrode active material set forth in the present invention, a superior battery performance can be obtained.

### BRIEF DESCRIPTION OF THE DRAWINGS

FIG. 1A and FIG. 1B show the X-ray diffractometer (XRD) patterns according to Embodiment 1, Embodiment 2, Embodiment 3 and Embodiment 4 of the present invention.

FIG. 2A and FIG. 2B show the pictures of transmission electron microscopy (TEM) and pictures of selected area electron diffraction (SAED) of each embodiment.

FIG. 2A(a) and FIG. 2A(b) show the TEM picture and the SAED picture of Comparative Embodiment 1; FIG. 2A(c) and FIG. 2A(d) show the TEM picture and the SAED picture of Embodiment 1; FIG. 2A(e) and FIG. 2A(f) show the TEM picture and the SAED picture of Embodiment 2.

FIG. 2B(a) and FIG. 2B(b) show the TEM picture and the SAED picture of Comparative Embodiment 2; FIG. 2B(c) and FIG. 2B(d) show the TEM picture and the SAED picture of Embodiment 3; FIG. 2B(e) and FIG. 2B(f) show the TEM picture and the SAED picture of Embodiment 4. The TEM pictures and SAED pictures through FIG. 2A to FIG. 2B demonstrate all the embodiments including Embodiment 1, Embodiment 2, Embodiment 3 and Embodiment 4 exhibit a uniform laminar structure.

FIG. 3A shows the relationship between the specific capacity and the voltage of the positive electrode active material for a lithium-ion battery according to Comparative Embodiment 1, Embodiment 1 and Embodiment 2 of the present invention; FIG. 3B shows the relationship between the cycle number and the specific capacity/energy density of the positive electrode active material for a lithium-ion battery according to Comparative Embodiment 1, Embodiment 1 and Embodiment 2 of the present invention.

FIG. 4A shows the relationship between the specific capacity and the voltage of the positive electrode active material for a lithium-ion battery according to Comparative Embodiment 2, Embodiment 3 and Embodiment 4 of the present invention; FIG. 4B shows the relationship between the cycle number and the specific capacity/energy density of the positive electrode active material for a lithium-ion battery according to Comparative Embodiment 2, Embodiment 3 and Embodiment 4 of the present invention.

### DETAILED DESCRIPTION OF THE PREFERRED EMBODIMENT

Those skilled in the art will readily observe that numerous modifications and alterations of the device and method may be made while retaining the teachings of the invention. Accordingly, the above disclosure should be construed as limited only by the metes and bounds of the appended claims.

In order to overcome the aforementioned problems of the conventional art, as well as to avoid using the rare cobalt as the raw material, the present invention relates to a positive electrode active material for a lithium-ion battery, which can be represented by the following formula (I):

Li_{1.2}NiₓMn_{0.8-x-y}Zn_{y}O₂ (I)

wherein the range of x is 0<x≤0.8 and the range of y is 0<y≤0.1. In one embodiment of the present invention, the range of x is 0.1≤x≤0.2, and the range of y is 0<y≤0.02. In one preferred embodiment of the present invention, the range of x is 0.2≤x≤0.3, and the range of y is 0<y≤0.02.

The present invention further provides a method of manufacturing a positive electrode active material for lithium-ion battery. First, a first solution is provided. The first solution includes a manganese salt solution (e.g., manganese acetate, manganese nitrate, or manganese sulfate, and is not limited thereto), a nickel salt solution (e.g., nickel acetate, nickel nitrate, or nickel sulfate, and is not limited thereto) and a zinc salt solution (e.g., zinc acetate, zinc nitrate, or zinc sulfate, and is not limited thereto). Next, a second solution is provided. The second solution includes a chelating agent (e.g., urea, acetylacetonate nickel, ethylenediamine, 2,2′-bipyridine, 1,10-phthalodiazepine, oxalic acid, 1,2-di(dimethylarsenyl) benzene or ethylenediaminetetraacetic acid, and is not limited thereto) and a buffer solution (e.g., sodium carbonate, sodium acetate, sodium hydroxide or sodium bicarbonate, and is not limited thereto). Then, the first solution is titrated into the second solution under a predetermined condition to produce a precipitation reaction, thereby forming a precursor material. In one embodiment, the predetermined condition refers to: titrating the first solution and the second solution into one container/beaker for the precipitation reaction, in which the first solution is titrated at a rate of, for example, 50 ml per minute, and the second solution is titrated at a controlled rate to maintain a pH range of 7 to 8, with a temperature maintained at 70° C. and stirring speed is approximately 1000 rpm for 24 hours to completely conduct the precipitation reaction. The precipitated solution is then washed by centrifugation to remove redundant ions to obtain a salt precipitate (namely, the precursor material). The precursor material is baked until being completely dry. Next, a lithium-containing compound (e.g., lithium carbonate, lithium acetate, or lithium hydroxide, but not limited to) is added to the material precursor according to predetermined chemical proportions. Lastly, after a heat treatment, e.g., at 800° C. to 950° C. for at least 10 hours (e.g., 12 hours), the positive electrode active material for a lithium electronic battery is obtained.

According to the above embodiment, the present invention further provides a lithium-ion battery having a positive electrode including the above-mentioned positive electrode active material. The lithium-ion battery (also referred to as “secondary battery”) according to the present embodiment includes a positive electrode containing the positive electrode active material described above, a negative electrode, and a non-aqueous electrolyte. The secondary battery may be any secondary battery which is charged and discharged by desorption and insertion of lithium ions and may be, for example, a non-aqueous electrolyte solution secondary battery or an all-solid-state lithium secondary battery. Note that, the embodiments described below are merely examples, and the lithium-ion secondary battery can be implemented in various modified and improved forms based on the knowledge of those skilled in the art including the following embodiments. Furthermore, the use of the secondary battery is not particularly limited.

Referring to the positive electrode, it can be prepared by using the positive electrode active material according to one embodiment of the present invention described above. An example of a method for producing the positive electrode will be described below. First, the above positive electrode active material (powder shape), a conductive material, and a binder are mixed, activated carbon and a solvent for viscosity adjustment or the like are further added as necessary, and the resulting mixture is kneaded to prepare a positive electrode mixture paste. The mixing ratio of the respective materials in the positive electrode mixture is a factor that determines the performance of the lithium-ion battery and thus can be adjusted according to the use. The mixing ratio of the materials can be similar to that of the positive electrode of any known lithium-ion battery, and for example, when the entire mass of the solids in the positive electrode mixture excluding the solvent is 100% by mass, the positive electrode active material can be contained at 60% to 95% by mass, the conductive material can be contained at 1% to 20% by mass, and the binder can be contained at 1% to 20% by mass. The obtained positive electrode mixture paste is applied to, for example, a surface of an aluminum foil current collector and dried to scatter the solvent, and a sheet-like positive electrode is thereby prepared. Pressurization may be performed by roll press or the like in order to increase an electrode density as necessary. The sheet-like positive electrode thus obtained can be cut into a proper size according to an intended battery and used in preparation of a battery. However, a method for preparing the positive electrode is not limited to the above-exemplified method, and other methods may be used. As the conductive material, for example, graphite (natural graphite, artificial graphite, expanded graphite, and the like), and a carbon black-based material such as acetylene black or ketjen black can be used. The binder plays a role of connecting active material particles together, and for example, polyvinylidene fluoride (PVDF), polytetrafluoroethylene (PTFE), fluororubber, ethylene propylene diene rubber, styrene butadiene, a cellulose-based resin, polyacrylic acid, and the like can be used. A solvent which disperses the positive electrode active material, the conductive material, and the activated carbon and dissolves the binding agent is added to the positive electrode mixture as necessary. As the solvent, specifically, an organic solvent such as N-methyl-2-pyrrolidone can be used. Furthermore, the activated carbon can be added to the positive electrode mixture in order to increase electric double layer capacity. The method of making the positive electrode is not limited to the method illustrated above, thus other methods may be used as well. For example, the positive electrode mixture can be pressure formed and then manufactured by drying under vacuum.

As the negative electrode, metal lithium, a lithium alloy, and the like can be used. Furthermore, as the negative electrode, a negative electrode may be used which is formed by mixing a binding agent with a negative electrode active material which can insert and de-insert lithium ions, adding a proper solvent thereto to form a paste-like negative electrode mixture, applying the paste-like negative electrode mixture to the surface of a metal foil current collector such as copper, drying the negative electrode mixture, and compressing the negative electrode mixture in order to increase the electrode density as necessary. Examples of the negative electrode active material include natural graphite, artificial graphite, a fired organic compound such as a phenol resin, and a powdery carbon material such as coke. In this case, as a negative electrode binding agent, a fluorine-containing resin such as PVDF can be used as in the positive electrode, and as a solvent for dispersing the active material and the binding agent, an organic solvent such as N-methyl-2-pyrrolidone can be used.

Referring to the separator, it is configured by being interposed between the positive electrode and the negative electrode. The separator separates the positive electrode and the negative electrode from each other and retains the electrolyte. A conventional separator can be used, and for example, a thin film such as polyethylene or polypropylene having a large number of minute pores can be used.

As to the non-aqueous electrolyte, for example, a non-aqueous electrolyte solution can be used. The non-aqueous electrolyte solution is obtained by dissolving a lithium salt as a supporting salt in an organic solvent. Furthermore, as the non-aqueous electrolyte solution, a solution obtained by dissolving a lithium salt in an ionic liquid may be used. It is noted that, the ionic liquid refers to a salt including a cation other than a lithium ion and an anion, and being in a liquid state even at room temperature. As the organic solvent, one selected from the group consisting of cyclic carbonates such as ethylene carbonate, propylene carbonate, butylene carbonate, and trifluoropropylene carbonate, chain carbonates such as diethyl carbonate, dimethyl carbonate, ethyl methyl carbonate, and dipropyl carbonate, further, ether compounds such as tetrahydrofuran, 2-methyltetrahydrofuran, and dimethoxyethane, sulfur compounds such as ethyl methyl sulfone and butane sultone, and phosphorus compounds such as triethyl phosphate and trioctyl phosphate can be used singly, or two or more of these can be used in mixture.

As the supporting salt, LiPF₆, LiBF₄, LiClO₄, LiAsF₆, LiN(CF₃SO₂)₂, a composite salt thereof, and the like can be used. Further, the non-aqueous electrolyte solution may contain a radical scavenger, a surfactant, a flame retardant, and the like. Furthermore, as the non-aqueous electrolyte, a solid electrolyte may be used. The solid electrolyte has a property capable of withstanding a high voltage. Examples of the solid electrolyte include an inorganic solid electrolyte and an organic solid electrolyte. Examples of the inorganic solid electrolyte include an oxide-based solid electrolyte and a sulfide solid electrolyte. The oxide-based solid electrolyte is not particularly limited, and for example, one that contains oxygen (O) and exhibits lithium ion conductivity and electron insulating property can be suitably used. As the oxide-based solid electrolyte, for example, one or more selected from the group consisting of lithium phosphate (Li₃PO₄), Li₃PO₄Nₓ, LiBO₂Nₓ, LiNbO₃, LiTaO₃, Li₂SiO₃, Li₄SiO₄-Li₃PO₄, Li₄SiO₄-Li₃VO₄, Li₂O—B₂O₃—P₂O₅, Li₂O—SiO₂, Li₂O—B₂O₃—ZnO, Li_{1+X}Al_{X}Ti_{2-X}(PO₄)₃(0≤X≤1), Li_{1+X}Al_{X}Ge_{2-X}(PO₄)₃ (0≤X≤1), LiTi₂(PO₄)₃, Li₃XLa_{2/3-X}TiO₃ (0≤X≤2/3), Li₅La₃Ta₂O₁₂, Li₇La₃Zr₂O₁₂, Li₆BaLa₂Ta₂O₁₂, and Li_{3.6}Si_{0.6}P_{0.4}O₄ can be used. The sulfide solid electrolyte is not particularly limited, and for example, one that contains sulfur (S) and exhibits lithium-ion conductivity and electron insulating property can be suitably used. As the sulfide solid electrolyte, for example, one or more selected from the group consisting of Li₂S—P₂S₅, Li₂S—SiS₂, LiI—Li₂S—SiS₂, LiI—Li₂S—P₂S₅, LiI—Li₂S—B₂S₃, Li₃PO₄-Li₂S—Si₂S, Li₃PO₄-Li₂S—SiS₂, LiPO₄-Li₂S—SiS, LiI—Li₂S—P₂O₅, and LiI—Li₃PO₄—P₂S₅ can be used. Note that, as the inorganic solid electrolyte, an inorganic solid electrolyte other than those described above may be used, and for example, Li₃N, LiI, Li₃N—LiI—LiOH, and the like may be used. The organic solid electrolyte is not particularly limited as long as it is a polymer compound exhibiting ionic conductivity, and for example, polyethylene oxide, polypropylene oxide, and copolymers of these can be used. Furthermore, the organic solid electrolyte may contain a supporting salt (lithium salt).

The shape of the secondary battery is not particularly limited, and the secondary battery can be formed into various shapes such as a cylindrical shape and a stacked shape. For example, when the secondary battery is a non-aqueous electrolyte solution secondary battery, a positive electrode and a negative electrode are stacked with a separator interposed therebetween to form an electrode body, the obtained electrode body is impregnated with a non-aqueous electrolyte solution, a positive electrode collector is connected to a positive electrode terminal communicating with the outside using a current collecting lead or the like, a negative electrode collector is connected to a negative electrode terminal communicating with the outside using a current collecting lead or the like, and the resulting product is sealed in a battery case to complete the secondary battery. Note that, the secondary battery according to the present embodiment is not limited to a form in which a non-aqueous electrolyte solution is used as a non-aqueous electrolyte but can be formed into, for example, a secondary battery using a solid non-aqueous electrolyte, that is, an all-solid-state battery. When the secondary battery according to the present embodiment is formed into the all-solid-state battery, the components other than the positive electrode active material can be changed as necessary.

The secondary battery according to the present embodiment can be used in any fields, due to its realized high thermal stability and low cost. In particular, the secondary battery is suitable for a power source of a small portable electronic device (such as a notebook personal computer or a mobile phone terminal) that is required to have a high capacity all the time. Also, the secondary battery is suitably used as a power source for electric cars that are restricted in a mounting space since microminiaturization and capacity enlargement thereof are possible. Note that, the secondary battery can be used not only as a power source for an electric car driven purely by electric energy but also as a power source for a so-called hybrid car used together with a combustion engine such as a gasoline engine or a diesel engine.

### Embodiments and Manufacturing Method

Please refer to Table 1 and Table, which show the compositions of the positive electrode active material of lithium-ion battery according to each embodiment of the present invention. As shown in Table 1, Comparative Embodiment 1 and Comparative Embodiment 2 show the positive electrode active material without Zn doping, Embodiment 1 and Embodiment 2 are positive electrode active material doped with increased Zn, Embodiment 3 and Embodiment 4 are positive electrode active material doped with increased Zn. Furthermore, Embodiment 1 and Embodiment 2 exhibit lower Ni/Mn ratio and Embodiment 3 and Embodiment 4 exhibit higher Ni/Mn ratio.

Referring to the manufacturing method, Comparative Embodiment 1 and Comparative Embodiment 2 are formed by a precipitation method (“co-precipitation”). First, two solutions are prepared according to the composition in Comparative Embodiment 1 and 2, respectively. One solution contains a manganese salt (such as manganese acetate, manganese nitrate, or manganese sulfate) and a nickel salt (such as nickel acetate, nickel nitrate, or nickel sulfate), and the other solution contains urea and sodium carbonate (both with a concentration of 1M). The two solutions are titrated into another beaker to conduct the co-precipitation interaction under a condition where the metal salt solution (manganese salt and nickel salt) is titrated in a speed of 50 ml/min, the other solution (urea and sodium carbonate) is titrated with a pH between 7˜8, and the titration temperature is maintained at approximate 70° C. and the stirring speed is about 1000 rpm for 24 hours to completely conduct the precipitation interaction. Next, the precipitation is washed by centrifugation to remove redundant ions to obtain a salt precipitate (the precursor material). The precursor material is baked until being completely dried. Subsequently, lithium carbonate is added to the material precursor according to the predetermined proportions and is mixed properly. Lastly, after a 800° C.-950° C. heat treatment for 12 hours, the powders of positive electrode active material of Comparative Embodiment 1 and Comparative Embodiment 2 can therefore be obtained.

Likewise, Embodiment 1, Embodiment 2, Embodiment 3 and Embodiment 4 are formed by the co-precipitation method. First, two solutions are prepared according to the composition in Embodiment 1, Embodiment 2, Embodiment 3 and Embodiment 4, respectively. One solution contains a manganese salt (such as manganese acetate, manganese nitrate, or manganese sulfate), a nickel salt (such as nickel acetate, nickel nitrate, or nickel sulfate) and a zinc salt (such as zinc acetate, zinc nitrate, or zinc sulfate), and the other solution contains urea and sodium carbonate (both with a concentration of 1M). The two solutions are titrated into another beaker to conduct the co-precipitation interaction under a condition where the metal salt solution (manganese salt, nickel salt and zinc salt) is titrated in a speed of 50 ml/min, the other solution (urea and sodium carbonate) is titrated with a pH between 7˜8, and the titration temperature is maintained at approximate 70° C. and the stirring speed is about 1000 rpm for 24 hours to completely conduct the precipitation interaction. Next, the precipitation is washed by centrifugation to remove redundant ions to obtain a salt precipitate (the precursor material). The precursor material is baked until completely dried. Subsequently, lithium carbonate is added to the material precursor according to the predetermined proportions and is mixed properly. Lastly, after a 800° C.-950° C. heat treatment for 12 hours, the powders of positive electrode active material in Embodiment 1, Embodiment 2, Embodiment 3 and Embodiment 4 can therefore be obtained respectively.

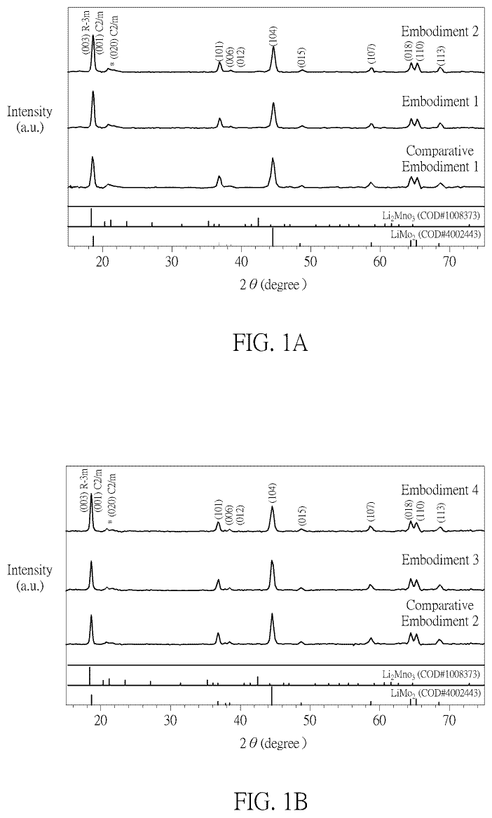

Please refer to FIG. 1A and FIG. 1B. FIG. 1A shows the X-ray diffractometer (XRD) pattern according to Embodiment 1 and Embodiment 2 of the present invention, while FIG. 1B shows the X-ray diffractometer pattern according to Embodiment 3 and Embodiment 4 of the present invention. For the detailed value of each peak in FIG. 1A and FIG. 1B, please refer to Table 2, in which the vacant areas (the horizontal lines “—”) between peak 2 to peak 5 indicate no reflection at the R3̅m angle. According to FIG. 1A and FIG. 1B, it is noted that, compared to the C2/m space group of the bottom monolithic LiMnO and the R3̅m space group of Rhombohedral LiMO₂, the lamination structure is not affected by doping Zn. In addition, there is no signal pattern of other zinc oxide, indicating that the zinc ion is doped uniformly into the material rather than generating oxides on the surface or producing local by-products.

TABLE 1

| | | | Element ratio in model from ICPMS | | | | Ni/ |
|---|---|---|---|---|---|---|---|
| | Modified Formula | Nominal Formula | Li | Ni | Mn | Zn | Mn |
| Comparative | Li_{1.25}Ni_{0.15}Mn_{0.6}O_{2-δ} | Li_{1.2}Ni_{0.2}Mn_{0.6}O₂ | 1.25 | 0.15 | 0.60 | — | 0.26 |
| Embodiment 1 | | | | | | | |
| Embodiment 1 | Li_{1.28}Ni_{0.14}Mn_{0.56}Zn_{0.01}O_{2-δ} | Li_{1.2}Ni_{0.19}Mn_{0.6}Zn_{0.01}O₂ | 1.28 | 0.14 | 0.56 | 0.011 | 0.25 |
| Embodiment 2 | Li_{1.27}Ni_{0.15}Mn_{0.56}Zn_{0.02}O_{2-δ} | Li_{1.1}Ni_{0.18}Mn_{0.6}Zn_{0.02}O₂ | 1.27 | 0.15 | 0.56 | 0.023 | 0.26 |
| Comparative | Li_{1.23}Ni_{0.26}Mn_{0.52}O_{2-δ} | Li_{1.2}Ni_{0.3}Mn_{0.5}O₂ | 1.23 | 0.26 | 0.52 | — | 0.50 |
| Embodiment 2 | | | | | | | |
| Embodiment 3 | Li_{1.25}Ni_{0.23}Mn_{0.51}Zn_{0.01}O_{2-δ} | Li_{1.2}Ni_{0.29}Mn_{0.5}Zn_{0.01}O₂ | 1.25 | 0.23 | 0.51 | 0.011 | 0.46 |
| Embodiment 4 | Li_{1.26}Ni_{0.22}Mn_{0.49}Zn_{0.02}O_{2-δ} | Li_{1.2}Ni_{0.28}Mn_{0.5}Zn_{0.02}O₂ | 1.26 | 0.22 | 0.49 | 0.023 | 0.45 |

TABLE 2

| peak | R3̅m | C2/m |
|---|---|---|
| 1 | 003 | 001 |
| 2 | — | 020 |
| 3 | — | 110 |
| 4 | — | 1̅11 |
| 5 | — | 021 |
| 6 | 101 | 111 |
| 7 | 006 | 002 |
| 8 | 012 | 131̅ |
| 9 | 104 | 131 |
| 10 | 015 | 132̅ |
| 11 | 107 | 132 |
| 12 | 018 | 133̅ |
| 13 | 110 | 331̅ |
| 14 | 113 | 061 |

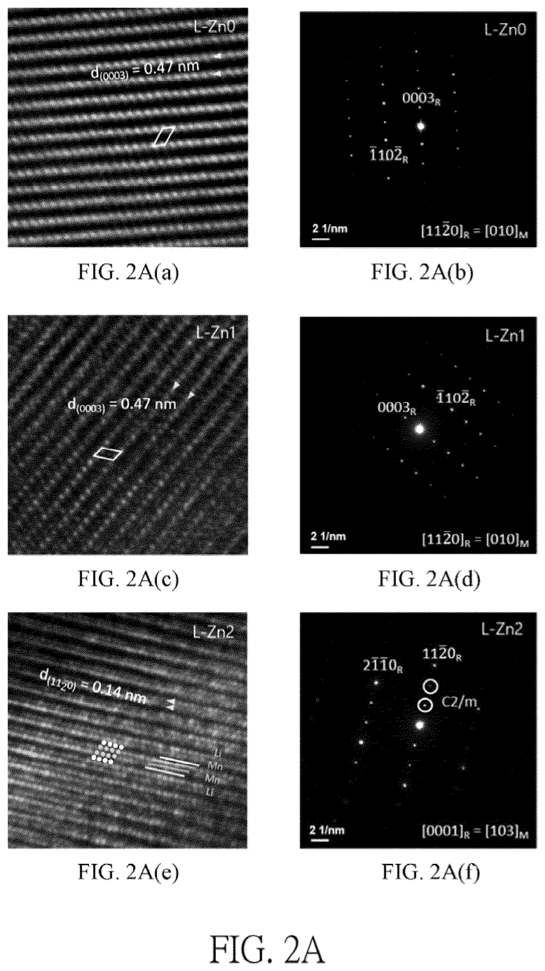

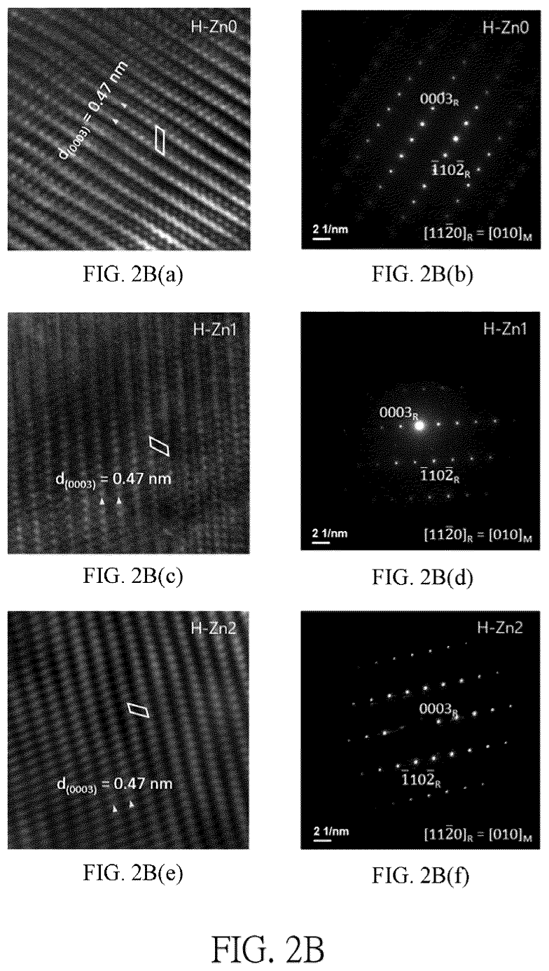

Please refer to FIG. 2A and FIG. 2B, which respectively show the pictures of transmission electron microscopy (TEM) and pictures of selected area electron diffraction (SAED) of each embodiment. In FIG. 2A, part (a) and part (b) show the TEM picture and the SAED picture of Comparative Embodiment 1; part (c) and part (d) show the TEM picture and the SAED picture of Embodiment 1; part (e) and part (f) show the TEM picture and the SAED picture of Embodiment 2. In FIG. 2B, part (a) and part (b) show the TEM picture and the SAED picture of Comparative Embodiment 2; part (c) and part (d) show the TEM picture and the SAED picture of Embodiment 3; part (e) and part (f) show the TEM picture and the SAED picture of Embodiment 4. The TEM pictures and SAED pictures through FIG. 2A to FIG. 2B demonstrate all the embodiments including Embodiment 1, Embodiment 2, Embodiment 3 and Embodiment 4 exhibit a uniform laminar structure.

Electricity of the Material

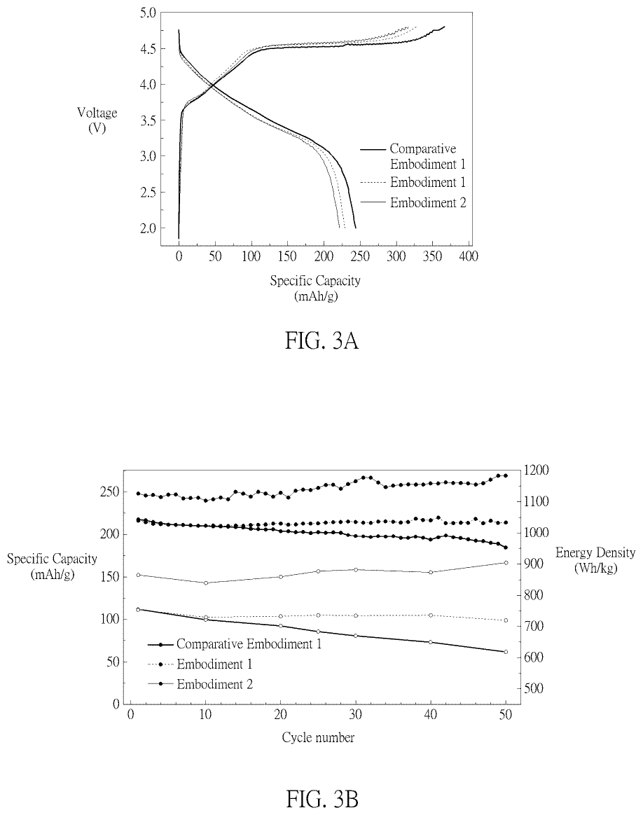

For the electricity performance of the positive electrode active material according to the above-motioned Comparative Embodiment 1, Embodiment 1 and Embodiment 2 (that is, the “low Ni/Mn ratio” group), please refer to FIG. 3A and FIG. 3B. FIG. 3A shows the relationship between the specific capacity and the voltage of the positive electrode active material for a lithium-ion battery according to Comparative Embodiment 1, Embodiment 1 and Embodiment 2 of the present invention, where the horizontal axis is the specific capacity (mAh/g) while the vertical axis shows the operation voltage (V) under 0.05C. The corresponding values are also shown in Table 3A. As shown in FIG. 3A and Table 3A, during charging, the specific capacity in the plateau area decreases as the proportion of zinc atoms increases (Comparative Embodiment 1→Embodiment 1→Embodiment 2), but the charge transfer efficiency remains approximately the same.

TABLE 3A

| | Charge (unit: mAg/g) | | | discharge | |
|---|---|---|---|---|---|
| | Slope | plateau | | (unit: | |
| | (3.5-4.4 V) | (4.4-4.8 V) | total | mAh/g) | efficiency(%) |
| Comparative | 93.8 | 269.5 | 363.3 | 243.7 | 67.1 |
| Embodiment 1 | | | | | |
| Embodiment 1 | 80.7 | 241.7 | 322.4 | 228.7 | 70.9 |
| Embodiment 2 | 86.2 | 225.5 | 311.7 | 221.3 | 71 |

Please refer to FIG. 3B, which shows the relationship between the cycle number and the specific capacity/energy density of the positive electrode active material for the lithium-ion battery according to Comparative Embodiment 1, Embodiment 1 and Embodiment 2 of the present invention, where the horizontal axis represents the cycle number (times), the left vertical axis represents the specific capacity (mAh/g) and the right vertical axis represents the energy density (Wh/kg). The experiment is conducted under 0.1C and the resulted value is correspondingly shown in Table 3B. As shown in FIG. 3B and the values in Table 3B, for the discharge capacity, whether in the 1^{st} cycle or in the 50^{th} cycle, the higher the doping of zinc atoms in the positive electrode active material of the lithium battery shown from in Comparative Embodiment 1 to Embodiment 1 and to Embodiment 2, the higher the discharge capacity and also the higher the recovery ratio of the battery capacity after 50 cycles. For the energy density, whether in the 1^{st} cycle or in the 50^{th} cycle, the higher the doping of zinc atoms in the positive electrode active material of the lithium battery shown from in Comparative Embodiment 1 to Embodiment 1 and to Embodiment 2, the higher the energy density and also the higher the recovery ratio of the battery capacity after 50 cycles. It is because in the lithium-rich material, it has poor electrical conductivity, and thereof requires more cycles to induce more lithium ion migrating in and out. However, during charging and discharging, the positive electrode material will also experience irreversible phase changes, which would hinder the lithium ion migrating in and out. The doped zinc ions can be used to stabilize the material structure and slow down the phase changes, thus allowing the material to release more capacitance without the influence of drastic phase changes.

TABLE 3B
Cycle number

| | Discharge (mAh/g) | | Recovery |
|---|---|---|---|
| | 1^{st} | 50^{th} | ratio(%) |
| Comparative Embodiment 1 | 217.7 | 184.4 | 84.7 |
| Embodiment 1 | 216.3 | 214.4 | 99.1 |
| Embodiment 2 | 248.2 | 269.1 | 108 |

| | Energy Density (Wh/kg) | | Recovery |
|---|---|---|---|
| | 1^{st} | 50^{th} | ratio (%) |
| Comparative Embodiment 1 | 755.5 | 669.6 | 88.6 |
| Embodiment 1 | 752.6 | 719.2 | 95.6 |
| Embodiment 2 | 864.4 | 903.9 | 105 |

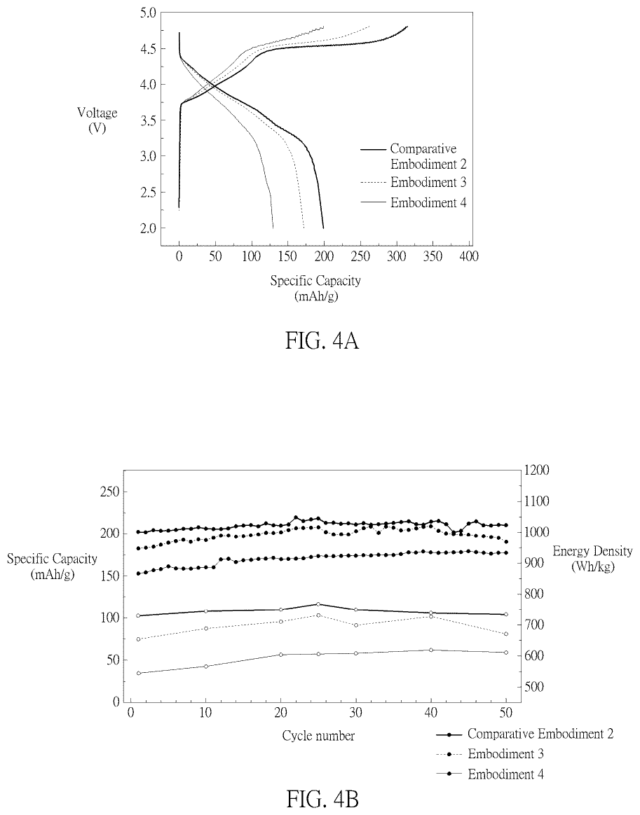

In comparison, for the electricity performance of the positive electrode active material according to the Comparative Embodiment 2, Embodiment 3 and Embodiment 4 (that is, the “high Ni/Mn ratio” group), please refer to FIG. 4A and FIG. 4B. FIG. 4A shows the relationship between the specific capacity and the voltage of the positive electrode active material for a lithium-ion battery according to Comparative Embodiment 2, Embodiment 3 and Embodiment 4 in the present invention, where the horizontal axis is the specific capacity (mAh/g) while the vertical axis shows the operation voltage (V) under 0.05C. The corresponding values are also shown in Table 4A. As shown in FIG. 4A and Table 4A, during charging, the specific capacity in the plateau area decreases as the proportion of zinc atoms increases (Comparative Embodiment 2→Embodiment 3→Embodiment 4), but the charge transfer efficiency remains approximately the same.

TABLE 4A

| | Charge (unit: mAg/g) | | | discharge | |
|---|---|---|---|---|---|
| | Slope | plateau | | (unit: | |
| | (3.5-4.4 V) | (4.4-4.8 V) | total | mAh/g) | efficiency(%) |
| Comparative | 107.5 | 206 | 313.5 | 199 | 63.5 |
| Embodiment 2 | | | | | |
| Embodiment 3 | 95.9 | 164.7 | 260.6 | 171.9 | 66 |
| Embodiment 4 | 82.3 | 115.1 | 197.4 | 129.8 | 65.8 |

Please refer to FIG. 4B, which shows the relationship between the cycle number and the specific capacity/energy density in the positive electrode active material of the lithium-ion battery according to Comparative Embodiment 2, Embodiment 3 and Embodiment 4 of the present invention, where the horizontal axis represents the cycle number (times), the left vertical axis represents the specific capacity (mAh/g) and the right vertical axis represents the energy density (Wh/kg). The experiment is conducted under 0.1C and the resulted value is correspondingly shown in Table 4B. As shown in FIG. 4B and the values in Table 4B, for the discharge capacity, whether in the 1^{st} cycle or in the 50^{th} cycle, though the discharge capacity decreases with the addition of more zinc atoms (from Comparative Embodiment 2→Embodiment 3→Embodiment 4), but the recovery ratio of the battery capacity after 50 cycles gradually increases. It is because in such high Ni material, although zinc can act as a stabilizing material ion, nickel can also act as a stabilizing material ion, and both ions occupy the laminar channels where lithium migrates in and out. Therefore, too much zinc doping will reduce the capacitance of the first turn, but at the same time, it also has the property of stabilizing the material and reducing the negative effect of phase change, so that the subsequent charging and discharging cycle will continue to activate the positive electrode material and release more capacitance. In terms of energy density, whether in the 1^{st} cycle or in the 50^{th} cycle, the more zinc atoms are incorporated into the positive electrode active material of the lithium-ion battery (from Comparative Embodiment 2 to Embodiment 4), the lower the discharge capacity it exhibits, but the higher the recovery ratio of the battery capacity in contains after 50 cycles. This is because in the positive electrode material, nickel acts as the stabilizing crystalline phase material, and because nickel usually occupies the lithium-ion transport channel, blocking the migration of lithium electrons in and out, which in turn affects the charge/discharge capacitance value. However, after subsequent activation in the charge/discharge cycle, more capacitance can be released, and because nickel stabilizes the material, the loss of capacitance due to phase change is reduced, and the capacitance can be increased in the subsequent charge/discharge cycle.

TABLE 4B
Cycle number

| | Discharge (mAh/g) | | Recovery |
|---|---|---|---|
| | 1^{st} | 50^{th} | ratio(%) |
| Comparative Embodiment 2 | 202.1 | 210.2 | 104 |
| Embodiment 3 | 182.5 | 190.5 | 104 |
| Embodiment 4 | 152.9 | 177.6 | 116 |

| | Energy Density (Wh/kg) | | Recovery |
|---|---|---|---|
| | 1^{st} | 50^{th} | ratio (%) |
| Comparative Embodiment 2 | 729.7 | 733.2 | 100 |
| Embodiment 3 | 654.4 | 670.7 | 103 |
| Embodiment 4 | 544.5 | 610.6 | 112 |

As demonstrated by the above FIGS. and Tables, the present invention provides a novel positive electrode active material for lithium-ion battery, which is expressed by the following formula (I):

Li_{1.2}NiₓMn_{0.8-x-y}Zn_{y}O₂ (I)

wherein x and y satisfy 0<x≤0.8 and 0<y≤0.1. According to the above-mention embodiments, as a positive electrode active material, in either the “low Ni/Mn ratio” group (Embodiment 1 and Embodiment 2, in which in formula (I) x and y satisfy 0.1≤x≤0.2 and 0<y≤0.02) or the “high Ni/Mn ratio” group (Embodiment 3 and Embodiment 4, in which in formula (I), x and y satisfy 0.2≤x≤0.3 and 0<y≤0.02), it can exhibit superior discharge capacity and energy density, whether in the 1^{st} cycle or in even up to the 50^{th} cycle. It is noted that in the “low Ni/Mn ratio” group, comparing to embodiment without doping zinc, the active material with doped zinc can dramatically increase the discharge capacity and the energy density, where the upgrade level is superior to the “high Ni/Mn ratio” group, indicating that the addition of zinc ion in positive electrode active material can help to stabilize the structure, especially in low Ni/Mn ratio.

In summary, the present invention provides a novel positive electrode active material for lithium-ion battery, which is feature by incorporating zinc ion. By using the manufacturing method for the positive electrode active material, a uniform and stable laminar structure can be produced. a superior battery performance can be obtained, which has been experimentally proven to have good electrical performance and is suitable for application in various electronic products.

What is claimed is:

1. A positive electrode active material for lithium-ion battery, having an average composition expressed by the following formula (I):
Li_{1.2}NiₓMn_{0.8-x-y}Zn_{y}O₂ (I)
wherein x and y satisfy 0<x≤0.8 and 0<y≤0.1.

2. The positive electrode active material for lithium-ion battery according to claim 1, wherein x and y satisfy 0.2≤x≤0.3 and 0<y≤0.02.

3. The positive electrode active material for lithium-ion battery according to claim 1, wherein x and y satisfy 0.1≤x≤0.2 and 0<y≤0.02.

4. A lithium-ion battery, comprising a positive electrode active material according to claim 1.

5. The lithium-ion battery according to claim 4, wherein x and y satisfy 0.2≤x≤0.3 and 0<y≤0.02.

6. The lithium-ion battery according to claim 4, wherein x and y satisfy 0.1≤x≤0.2 and 0<y≤0.02.

7. A method of manufacturing a positive electrode active material for lithium-ion battery, comprising:
providing a first solution, comprising a manganese salt solution, a nickel salt solution and a zinc salt solution;
providing a second solution, comprising a chelating agent and a buffer solution;
titrating the first solution into the second solution under a predetermined condition to produce a precipitation reaction, thereby forming a precursor material;
adding a lithium-containing compound into the precursor material; and
performing a heat process to obtain the positive electrode active material.

8. The method of manufacturing a positive electrode active material for lithium-ion battery according to claim 7, wherein the predetermined condition comprises:
maintaining a pH value between 7 and 8.

9. The method of manufacturing a positive electrode active material for lithium-ion battery according to claim 7, wherein the predetermined condition comprises:
maintaining a temperature between 60 and 80 Celsius degrees.

10. The method of manufacturing a positive electrode active material for lithium-ion battery according to claim 7, wherein the heat process comprises:
treating at least 10 hours at 800˜950 Celsius degrees.
